(19) United States
(12) Patent Application Publication
(10) Pub. No.: US 2007/0169792 A1
(43) Pub. Date: Jul. 26, 2007

(54) Apparatus and method of chemical separation

(76) Inventor: Herman Itzkowitz, Bala Cynwyd, PA (US)

Correspondence Address: JOHN W. GOLDSCHMIDT, JR. ESQUIRE;DILWORTH PAXON LLP, 3200 MELLON BANK CENTER, 1735 MARKET STREET, PHILADELPHIA, PA, 19103, US

(21) Appl. No.: 11/640,044

(22) Filed: Dec. 15, 2006

Related U.S. Application Data
(60) Provisional application No. 60/751,025, filed on Dec. 16, 2005.

(51) Int. Cl. B08B 3/00; B08B 7/00; B08B 7/04; B08B 3/04

(52) U.S. Cl. 134/10; 134/104.2; 134/149; 134/26; 134/33

(57) ABSTRACT

An apparatus and method for processing substrates such as silicon wafers, wherein process chemicals or other fluids are used on the top or other surface of the substrate followed by a de-ionized water (“DI”) or other fluid rinse. The used process chemicals or fluids are separated from the rinsing fluid with very little or no cross contamination between the two fluids. The apparatus consists of an annular collection chamber and spin chuck. During chemical processing, the fluids flow substantially horizontally on the top or other surface of a rotating wafer and are collected by the collection chamber on the periphery. Once chemical processing is complete, the collection chamber moves down to a closed position as shown in FIG. 2. DI water or other fluid may then be dispensed to rinse the wafer without mixing with the chemical or other processing fluid collected in the chamber.

### CROSS REFERENCE TO RELATED APPLICATION

This application claims the priority of U.S. Provisional Patent Application Ser. No. 60/751,025, filed Dec. 16, 2005, entitled “Apparatus and Method of Chemical Separation”, under 35 U.S.C. §119 (e), the entire contents of which are incorporated herein by reference.

### FIELD OF THE INVENTION

This invention generally relates to an apparatus and method for chemical separation. More specifically, this invention relates to an apparatus and method for the separation of chemicals or maintaining the separation of chemicals used in the manufacture of integrated circuit substrate wafers such that such chemicals may be recycled or reused in the further processing of wafers, or otherwise disposed of.

### BACKGROUND OF THE INVENTION

Integrated circuit wafers, which typically are in the form of flat round disks (although other shapes are possible) and often are made from silicon, Gallium Arsenide, or other materials, may be processed using various chemicals. Some of the steps employed in such processes are: coating, developing, etching, striping, metal liftoff, etc. Commonly used methods include submerging the wafers in chemical baths (referred to as “batch processing”), or dispensing fluid on a wafer while spinning (referred to as “single wafer processing”) such as in, for example, wet chemical etching processes. As wafer sizes increase, substantial benefits may be realized by employing single wafer processing inasmuch as the processing environment may be better controlled.

Dispensing process fluids on a wafer followed by a de-ionized (“DI”) water rinse causes the fluids to be mixed and render the fluids unsuitable for recycling or reuse. Thus, methods are employed to separate the fluids for recycling or reuse. Methods used for separation of fluids include drain diverters and various splash shields to divert the fluids to separate drains. However, such methods still allow for some mixing of DI water into the process fluids, making the process fluid unsuitable for reuse, or severely limiting how many times the fluid can be re-circulated.

Thus, there exists a need for an apparatus and method for separating fluids or maintaining the separation of fluids used in the manufacture of integrated circuit or other substrate wafers, wherein such separated fluids may be reused in future processing or may be otherwise recycled or disposed.

### SUMMARY OF THE INVENTION

This problem may be solved by employing an apparatus and method which allows for chemicals used in integrated circuit wafer or other substrate processing to be disposed on the substrate surface during processing and isolating excess chemicals as the substrate is rinsed with suitable rinsing fluid such as DI water. Thus, in the process of this invention DI water does not mix with or otherwise contaminate the used process fluids, such as chemical fluids, allowing for the reuse or recycling of such process fluids.

One embodiment of the instant invention allows for the collection of process fluids during the chemical cycle, while substantially sealing a collection chamber during the rinsing and drying cycle. Thus, the process fluid remains free of rinsing fluids, such as DI water, allowing the process fluid to be recirculated and reused to process additional substrates such as integrated circuit wafers.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts, and wherein:

FIG. 1 depicts a cross sectional elevation of a spin chuck and collection chamber of the present invention wherein the collection chamber is in a substantially open position;

FIG. 2 depicts a cross sectional elevation of the spin chuck and collection chamber of FIG. 1 wherein the collection chamber is in a substantially closed position;

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements which may be found in the present invention. Those of ordinary skill in the pertinent art will recognize that other elements are desirable and/or required in order to implement the present invention. However, because such elements are well known in the art, and because such elements do not facilitate a better understanding of the present invention, a discussion of such elements is not provided herein.

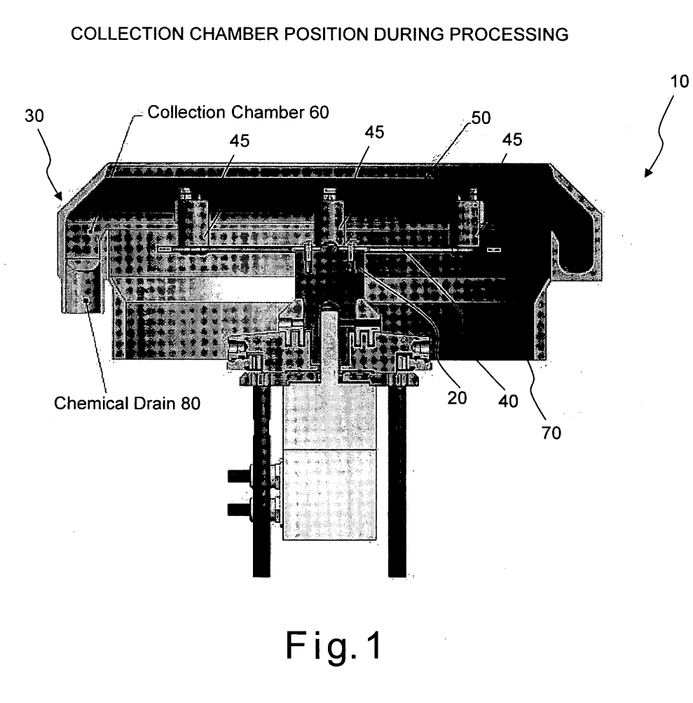

Turning now to FIG. 1, there is shown one embodiment of apparatus 10 of the instant invention. Apparatus 10 comprises spin chuck 20 and vertically movable chemical collection system 30. Spin chuck 30 comprises a platform 40, which may be rotated on a horizontal plane and upon which wafer 50 may be placed for chemical processing. Wafer 50 is secured to platform 40 during processing such that it remains stationary relative to rotating platform 40. Depending on the configuration desired, wafer 50 may be secured to standoffs 45 which are themselves secured to platform 40.

Chemical collection system 30 comprises an annular, vertically positionable collection chamber 60, collection chamber cover 70 and drain 80. Collection chamber 60 permits chemicals or other fluids introduced during the processing of wafer 50 to be collected as wafer 50 spins. Collection of fluids in collection chamber 60 is achieved during chemical processing because, as the process fluids deposited on wafer 50 flow in a horizontal direction on the top surface of rotating wafer 50, excess fluid is released from the surfaces of wafer 50 by centrifugal force generated by the rotation of wafer 50.

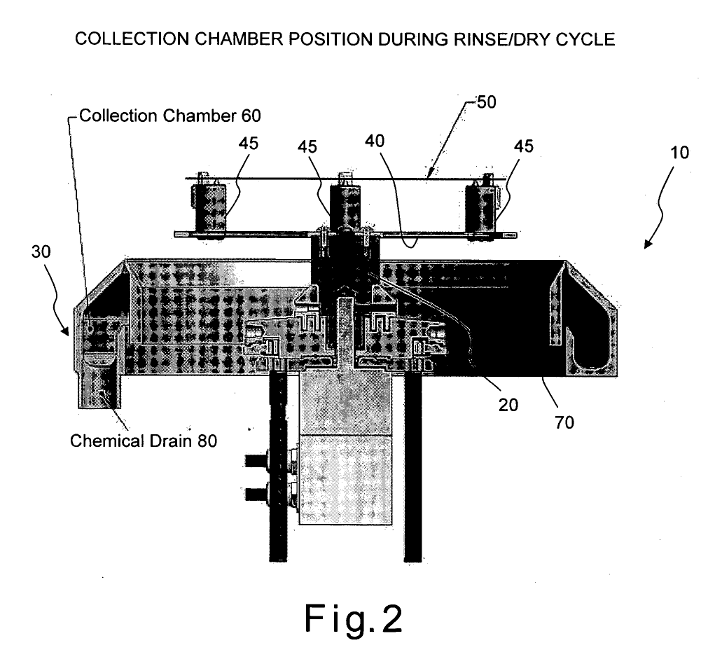

As shown in FIG. 1, collection chamber 60 remains in an open position during the chemical processing of wafer 50 in order to permit the collection of the process fluids in chamber 60. Once chemical processing of wafer 50 is complete, and the process fluids are collected in chamber 60, chamber 60 may be moved into a closed position, as shown in FIG. 2. In the closed position, collection chamber cover 70 substantially seals collection chamber 60 such that fluids may not enter chamber 60. Thus, wherein the closed position chamber cover 70 permits the rinsing of wafer 50 with a rinsing fluid, such as, for example, DI water, without permitting the rinsing fluids to mix with the process fluids collected in chemical collection system 30.

In one embodiment of the invention, collection chamber cover 70 may be affixed to spin chuck 20 or other stationary object, such that collection chamber 60 may be moved into a rinse or closed position, as shown in FIG. 2 and collection chamber cover 70 covers the opening to collection chamber 60. As a result, the process fluids are substantially prevented from entering chamber 60. As process fluids are collected in collection chamber 60, the process fluids are substantially isolated from the rinsing fluids, and the process fluids may be carried away through chamber drain 80 for reuse, recycling or other disposition without the need for further treatment of the process fluids.

The disclosure herein is directed to certain features of the elements and methods of the invention disclosed as well as others that will be apparent to those skilled in the art in light of the disclosure herein. Thus, it is intended that the present invention covers all such modifications and variations of this invention, provided that those modifications come within the scope of the claims granted herein and the equivalents thereof.

What is claimed is:

1. An apparatus for wet chemical processing of wafers comprising:
a wafer chuck which supports and rotates the wafer;
fluid dispensing nozzles capable of delivering chemical fluids and DI water to the surface of the wafer; and
an annular collection chamber, which moves in a substantially vertical direction, resulting in an open position for collecting fluids, or a closed substantially sealed position for diverting fluids away from the collection chamber, the collection chamber having a drain used to collect the collected fluids.

2. An apparatus for processing substrates with one or more process fluids and rinsing said substrate with a ringing fluid, said apparatus comprising:
a chuck capable supporting and rotating said substrate;
a collection system capable of collecting said process fluids for recycling, reuse or other disposition such that said collected process fluids are substantially free from said rinsing fluid.

3. An apparatus for processing substrates with one or more process fluids and rinsing said substrate with one or more rinsing fluids, said apparatus comprising:
a chuck capable of supporting and rotating said substrate;
a collection system further comprising:
a substantially vertically positionable collection chamber; and
a collection chamber cover wherein when said collection chamber is in a first position, said chamber is open to receive process fluids, and when said collection chamber is in a second position, said chamber is closed to substantially prevent rinsing fluids from entering said chamber.

4. The apparatus of claim 3, further comprising:
a drain in fluid communication with said chamber through which said process fluids may pass and may be recycled for reuse in future processing of substrate materials or otherwise used or disposed of.

5. A method for substantially maintaining the separation of process and rinsing fluids used in the processing of substrate materials, said substrate having upper and lower surfaces, and wherein said method comprises the steps of:
securing said substrate to a rotating chuck;
rotating said chuck as said process fluids are applied to said top surface of said substrate;
collecting excess process fluid in a variably positionable collection chamber as said collection chamber is in a substantially open position;
positioning said collection chamber in a substantially closed position;
applying a rinsing fluid to said rotating substrate while said collection chamber is in a substantially closed position; and
collecting said rinsing fluid such that said processing fluid is substantially free from said rinsing fluid and said processing fluid may be reused in future substrate processing or otherwise disposed of.
